(19) United States
(12) Patent Application Publication
(10) Pub. No.: US 2025/0301388 A1
(43) Pub. Date: Sep. 25, 2025

(54) RESOLVING AMBIGUITY OF USER EQUIPMENT SERVING LOCATION IN MOBILITY PROCEDURES

(71) Applicant: QUALCOMM Incorporated, San Diego, CA (US)

(72) Inventors: Doohyun SUNG, Basking Ridge, NJ (US); Naeem AKL, BRIDGEWATER, NJ (US); Jelena DAMNJANOVIC, Del Mar, CA (US)

(21) Appl. No.: 19/044,261

(22) Filed: Feb. 3, 2025

Related U.S. Application Data
(60) Provisional application No. 63/569,679, filed on Mar. 25, 2024.

(51) Int. Cl. H04W 36/32; H04W 36/08; H04W 76/20

(52) U.S. Cl. CPC H04W 36/324; H04W 36/08; H04W 76/20

(57) ABSTRACT

Methods, systems, and devices for wireless communications are described. A first source network entity may obtain an indication from a user equipment (UE) that a lower-layer trigger mobility (LTM) procedure has occurred, where the UE transferred a communication session from a second source network entity to the first source network entity. The first source network entity may output one or more access notifications to one or more candidate network entities, and obtain from at least one of the one or more candidate network entities, one or more updated configuration indications. The one or more updated configuration indications indicate updated LTM mobility procedure information at one or more of the one or more candidate network entities. In some examples, one or more candidate network entities, an anchor network entity, or a combination thereof may obtain and output access notifications and updated configuration indications.

### CROSS REFERENCE

The present Application for Patent claims the benefit of U.S. Provisional Patent Application No. 63/569,679 by SUNG et al., entitled “RESOLVING AMBIGUITY OF USER EQUIPMENT SERVING LOCATION IN MOBILITY PROCEDURES” filed Mar. 25, 2024, assigned to the assignee hereof, and expressly incorporated by reference herein.

### FIELD OF TECHNOLOGY

The following relates to wireless communications, including resolving ambiguity of user equipment serving location in mobility procedures.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

A UE may communicate with one or more network entities. The UE may transfer communications from one network entity to another via a mobility procedure, such as a handover procedure.

### SUMMARY

The described techniques relate to improved methods, systems, devices, and apparatuses that support resolving ambiguity of user equipment (UE) serving location in mobility procedures. For example, the described techniques provide for lower-layer trigger mobility (LTM) procedures between one or more network entities and the UE. The network entities may be source network entities, candidate network entities, anchor network entities, etc.

A method by a first source network entity is described. The method may include obtaining an indication from a user equipment (UE) that a lower-layer trigger mobility (LTM) procedure has occurred, where the LTM procedure includes the UE transferring a communication session from a second source network entity to the first source network entity, outputting, based at least in part on the UE transferring the communication session, one or more access notifications to one or more candidate network entities, and obtaining, from at least one of the one or more candidate network entities, one or more updated configuration indications based on the one or more access notifications, where the one or more updated configuration indications indicate updated LTM procedure information at one or more of the one or more candidate network entities.

A first source network entity is described. The first source network entity may include one or more memories storing processor executable code, and one or more processors coupled with the one or more memories. The one or more processors may individually or collectively be operable to execute the code to cause the first source network entity to obtain an indication from a UE that a LTM procedure has occurred, where the LTM procedure includes the UE transferring a communication session from a second source network entity to the first source network entity, output, based on the UE transferring the communication session, one or more access notifications to one or more candidate network entities, and obtain, from at least one of the one or more candidate network entities, one or more updated configuration indications based on the one or more access notifications, where the one or more updated configuration indications indicate updated LTM procedure information at one or more of the one or more candidate network entities.

Another first source network entity is described. The first source network entity may include means for one or more memories storing processor-executable code, means for one or more processors coupling with the one or more memories, and means for obtaining an indication from a UE that a LTM procedure has occurred, where the LTM procedure includes the UE transferring a communication session from a second source network entity to the first source network entity, means for output, based at least in part on the UE transferring the communication session, one or more access notifications to one or more candidate network entities, and means for obtaining, from at least one of the one or more candidate network entities, one or more updated configuration indications based on the one or more access notifications, where the one or more updated configuration indications indicate updated LTM procedure information at one or more of the one or more candidate network entities.

A non-transitory computer-readable medium storing code is described. The code may include instructions executable by one or more processors to obtain an indication from a UE that a LTM procedure has occurred, where the LTM procedure includes the UE transferring a communication session from a second source network entity to the first source network entity, output, based on the UE transferring the communication session, one or more access notifications to one or more candidate network entities, and obtain, from at least one of the one or more candidate network entities, one or more updated configuration indications based on the one or more access notifications, where the one or more updated configuration indications indicate updated LTM procedure information at one or more of the one or more candidate network entities.

In some examples of the method, first source network entities, and non-transitory computer-readable medium described herein, outputting the one or more access notifications may include operations, features, means, or instructions for outputting a first access notification to the second source network entity and output one or more second access notifications to one or more other network entities, where the first access notification indicates successful transfer of the communication session to the first source network entity and where the one or more second access notifications indicate that the first source network entity may be a serving entity of the UE.

In some examples of the method, first source network entities, and non-transitory computer-readable medium described herein, outputting the one or more access notifications may include operations, features, means, or instructions for outputting a first access notification to the second source network entity, where obtaining the one or more updated configuration indications may be further based on signaling transmitted, in response to the first access notification, from the second source network entity to one or more of the one or more candidate network entities.

In some examples of the method, first source network entities, and non-transitory computer-readable medium described herein, output one or more reconfiguration messages to the UE based on the one or more updated configuration indications.

In some examples of the method, first source network entities, and non-transitory computer-readable medium described herein, the one or more reconfiguration messages include radio resource control signaling (RRC).

Some examples of the method, first source network entities, and non-transitory computer-readable medium described herein may further include operations, features, means, or instructions for obtaining the indication from the UE may be further based on a prior mobility procedure other than a successful LTM procedure.

A method for wireless communications by a first source network entity is described. The method may include obtaining an indication from a UE that a LTM procedure has occurred, where the LTM procedure includes the UE transferring a communication session from a second source network entity to the first source network entity, outputting, based on the UE transferring the communication session, one or more access notifications to one or more candidate network entities, and obtaining, from at least one of the one or more candidate network entities, one or more updated configuration indications based on the one or more access notifications, where the one or more updated configuration indications indicate updated LTM procedure information at one or more of the one or more candidate network entities.

A first source network entity for wireless communications is described. The first source network entity may include one or more memories storing processor executable code, and one or more processors coupled with the one or more memories. The one or more processors may individually or collectively be operable to execute the code to cause the first source network entity to obtain an indication from a UE that a LTM procedure has occurred, where the LTM procedure includes the UE transferring a communication session from a second source network entity to the first source network entity, output, based on the UE transferring the communication session, one or more access notifications to one or more candidate network entities, and obtain, from at least one of the one or more candidate network entities, one or more updated configuration indications based on the one or more access notifications, where the one or more updated configuration indications indicate updated LTM procedure information at one or more of the one or more candidate network entities.

Another first source network entity for wireless communications is described. The first source network entity may include means for obtaining an indication from a UE that a LTM procedure has occurred, where the LTM procedure includes the UE transferring a communication session from a second source network entity to the first source network entity, means for outputting, based on the UE transferring the communication session, one or more access notifications to one or more candidate network entities, and means for obtaining, from at least one of the one or more candidate network entities, one or more updated configuration indications based on the one or more access notifications, where the one or more updated configuration indications indicate updated LTM procedure information at one or more of the one or more candidate network entities.

A non-transitory computer-readable medium storing code for wireless communications is described. The code may include instructions executable by one or more processors to obtain an indication from a UE that a LTM procedure has occurred, where the LTM procedure includes the UE transferring a communication session from a second source network entity to the first source network entity, output, based on the UE transferring the communication session, one or more access notifications to one or more candidate network entities, and obtain, from at least one of the one or more candidate network entities, one or more updated configuration indications based on the one or more access notifications, where the one or more updated configuration indications indicate updated LTM procedure information at one or more of the one or more candidate network entities.

In some examples of the method, first source network entities, and non-transitory computer-readable medium described herein, outputting the one or more access notifications may include operations, features, means, or instructions for outputting a first access notification to the second source network entity and outputting one or more second access notifications to one or more other network entities, where the first access notification indicates successful transfer of the communication session to the first source network entity and where the one or more second access notifications indicate that the first source network entity may be a serving entity of the UE.

In some examples of the method, first source network entities, and non-transitory computer-readable medium described herein, outputting the one or more access notifications may include operations, features, means, or instructions for outputting a first access notification to the second source network entity, where obtaining the one or more updated configuration indications may be further based on signaling transmitted, in response to the first access notification, from the second source network entity to one or more of the one or more candidate network entities.

Some examples of the method, first source network entities, and non-transitory computer-readable medium described herein may further include operations, features, means, or instructions for outputting one or more reconfiguration messages to the UE based on the one or more updated configuration indications.

In some examples of the method, first source network entities, and non-transitory computer-readable medium described herein, the one or more reconfiguration messages include radio RRC.

Some examples of the method, first source network entities, and non-transitory computer-readable medium described herein may further include operations, features, means, or instructions for obtaining the indication from the UE may be further based on a prior mobility procedure other than a successful LTM procedure.

A method for wireless communications by an apparatus is described. The method may include obtaining an indication from a UE that a LTM procedure has occurred, where the LTM procedure includes the UE transferring a communication session from a second source network entity to a first source network entity, output, based at least in part on the UE transferring the communication session, one or more access notifications to one or more candidate network entities, and obtaining, from at least one of the one or more candidate network entities, one or more updated configuration indications based on the one or more access notifications, where the one or more updated configuration indications indicate updated LTM procedure information at one or more of the one or more candidate network entities.

An apparatus for wireless communications is described. The apparatus may include one or more memories storing processor executable code, and one or more processors coupled with the one or more memories. The one or more processors may individually or collectively be operable to execute the code to cause the apparatus to obtain an indication from a UE that a LTM procedure has occurred, where the LTM procedure includes the UE transferring a communication session from a second source network entity to a first source network entity, output, based on the UE transferring the communication session, one or more access notifications to one or more candidate network entities, and obtain, from at least one of the one or more candidate network entities, one or more updated configuration indications based on the one or more access notifications, where the one or more updated configuration indications indicate updated LTM procedure information at one or more of the one or more candidate network entities.

Another apparatus for wireless communications is described. The apparatus may include means for obtaining an indication from a UE that a LTM procedure has occurred, where the LTM procedure includes the UE transferring a communication session from a second source network entity to a first source network entity, means for output, based at least in part on the UE transferring the communication session, one or more access notifications to one or more candidate network entities, and means for obtaining, from at least one of the one or more candidate network entities, one or more updated configuration indications based on the one or more access notifications, where the one or more updated configuration indications indicate updated LTM procedure information at one or more of the one or more candidate network entities.

A non-transitory computer-readable medium storing code for wireless communications is described. The code may include instructions executable by one or more processors to obtain an indication from a UE that a LTM procedure has occurred, where the LTM procedure includes the UE transferring a communication session from a second source network entity to a first source network entity, output, based on the UE transferring the communication session, one or more access notifications to one or more candidate network entities, and obtain, from at least one of the one or more candidate network entities, one or more updated configuration indications based on the one or more access notifications, where the one or more updated configuration indications indicate updated LTM procedure information at one or more of the one or more candidate network entities.

In some examples of the method, apparatus, and non-transitory computer-readable medium described herein, outputting the one or more access notifications may include operations, features, means, or instructions for outputting a first access notification to the second source network entity and output one or more second access notifications to one or more other network entities, where the first access notification indicates successful transfer of the communication session to the first source network entity and where the one or more second access notifications indicate that the first source network entity may be a serving entity of the UE.

In some examples of the method, apparatus, and non-transitory computer-readable medium described herein, outputting the one or more access notifications may include operations, features, means, or instructions for outputting a first access notification to the second source network entity, where obtaining the one or more updated configuration indications may be further based on signaling transmitted, in response to the first access notification, from the second source network entity to one or more of the one or more candidate network entities.

In some examples of the method, apparatus, and non-transitory computer-readable medium described herein, output one or more reconfiguration messages to the UE based on the one or more updated configuration indications.

In some examples of the method, apparatus, and non-transitory computer-readable medium described herein, the one or more reconfiguration messages include radio RRC.

Some examples of the method, apparatus, and non-transitory computer-readable medium described herein may further include operations, features, means, or instructions for obtaining the indication from the UE may be further based on a prior mobility procedure other than a successful LTM procedure.

### BRIEF DESCRIPTION OF THE DRAWINGS

FIG. 1 shows an example of a wireless communications system that supports resolving ambiguity of user equipment (UE) serving location in mobility procedures in accordance with one or more aspects of the present disclosure.

FIG. 2 shows an example of a wireless communications system that supports resolving ambiguity of UE serving location in mobility procedures in accordance with one or more aspects of the present disclosure.

FIG. 3 shows an example of a process flow diagram that supports resolving ambiguity of UE serving location in mobility procedures in accordance with one or more aspects of the present disclosure.

FIG. 4 shows an example of a process flow diagram that supports resolving ambiguity of UE serving location in mobility procedures in accordance with one or more aspects of the present disclosure.

FIG. 5 shows an example of a process flow diagram that supports resolving ambiguity of UE serving location in mobility procedures in accordance with one or more aspects of the present disclosure.

FIG. 6 shows an example of a process flow diagram that supports resolving ambiguity of UE serving location in mobility procedures in accordance with one or more aspects of the present disclosure.

FIG. 7 shows an example of a process flow diagram that supports resolving ambiguity of UE serving location in mobility procedures in accordance with one or more aspects of the present disclosure.

FIGS. 8 and 9 show block diagrams of devices that support resolving ambiguity of UE serving location in mobility procedures in accordance with one or more aspects of the present disclosure.

FIG. 10 shows a block diagram of an mobility communications manager that supports resolving ambiguity of UE serving location in mobility procedures in accordance with one or more aspects of the present disclosure.

FIG. 11 shows a diagram of a system including a device that supports resolving ambiguity of UE serving location in mobility procedures in accordance with one or more aspects of the present disclosure.

FIGS. 12 through 14 show flowcharts illustrating methods that support resolving ambiguity of UE serving location in mobility procedures in accordance with one or more aspects of the present disclosure.

### DETAILED DESCRIPTION

A user equipment (UE) may move from the coverage area of one network entity, or cell, to the coverage area of another. To continue communications with the network, the UE may connect with a new (e.g., source, target, serving) network entity. Various procedures may be used to transfer a communication session from one network entity to another, such as a conditional handover procedure or a lower-layer trigger mobility (LTM) procedure. Multiple candidate network entities may be configured to be able to service the UE, while in some examples one network entity may serve as a current source or serving network entity. In some examples, candidate cells may have outdated configuration information with respect to when the candidate cells or network entities were first configured for a mobility procedure. For example, the UE may be configured to complete a conditional handover from the first source network entity to the second network entity, and a third network entity may have outdated configuration information. If the conditional handover for the UE has not yet been triggered, such that the source network entity of the UE has not yet changed, the third network entity may send a message to the first source network entity indicating that the conditional handover configuration at the third network entity is outdated. If the UE has been triggered to transfer to the second network entity, the first network entity may send a cancel message to the third network entity indicating that the outdated conditional handover configuration is no longer relevant and that the second network entity is the source network entity. In such examples, the third network entity is updated as to a change in source network entity for the UE after a conditional handover procedure.

Another mobility procedure is LTM, where the UE may not release stored LTM configuration information of a network entity without explicit indication to do so. LTM may be implemented in lower-layers, such as layer 1 and layer 2. In an LTM procedure, the UE may be notified of any configuration updates of candidates cells by the source network entity. However, if the third network entity has outdated configuration information for the UE, the third network entity may not be updated as to which network entity is the current source network entity of the UE, and may not be able to notify the source network entity of any updates. In such examples, there is ambiguity for the third network entity, or any candidate network entity, with outdated configuration information.

Techniques described herein provide for signaling between network entities configured for LTM procedures to communicate updated cell handover information and configurations. The UE may receive an LTM configuration from a source network entity indicating for the UE to transfer the communication session from the source network entity to a new source network entity. The UE may contact the new source network entity as part of the LTM procedure. After successful LTM, the network entities may communicate updated configuration information, and the source network entity may reconfigure the UE.

In a first example, the new source network entity may notify the previous source network entity, other candidate network entities, or both, of the successful LTM. In some examples, the previous source network entity may forward the notification to the candidate network entities. In a second example, a candidate network entity with outdated information may, without receiving any updates, output updated configuration indications to one or more of the other candidate network entities. For example, the candidate network entity may output a broadcast message, or may query to identify the source network entity. In a third example, a network entity may be designated as an anchor, and forward updated configuration indications. For example, the anchor network entity may receive an update from a candidate network entity and forward the update to the source network entity or all the candidate network entities. In some examples, the anchor network entity may query as to identify the source network entity prior to forwarding any updates. Such techniques resolve ambiguity as to UE location information for LTM procedures.

Aspects of the disclosure are initially described in the context of wireless communications systems. Aspects of the disclosure are further illustrated by and described with reference to process flow diagrams, apparatus diagrams, system diagrams, and flowcharts that relate to resolving ambiguity of UE serving location in mobility procedures.

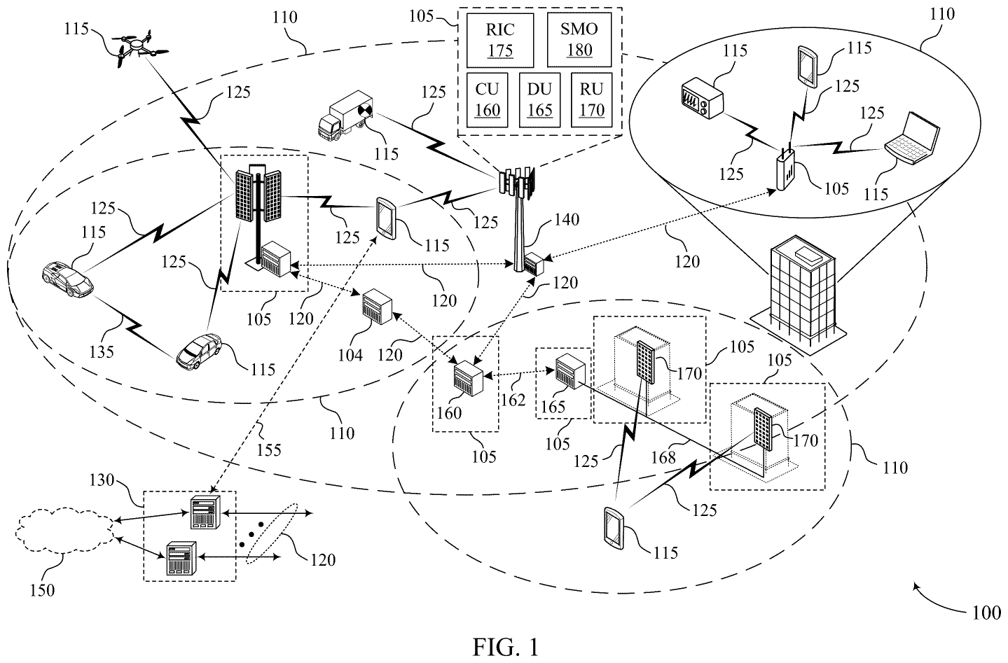

FIG. 1 shows an example of a wireless communications system 100 that supports resolving ambiguity of UE serving location in mobility procedures in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

Techniques described herein provide for signaling between the network entities 105 configured for LTM procedures to communicate updated cell handover information and configurations. The UE 115 may receive an LTM configuration from a source network entity 105 indicating for the UE 115 to transfer the communication session from the source network entity to a new source network entity 105. The UE 115 may contact the new source network entity 105 as part of the LTM procedure. After successful LTM, the network entities 105 may communicate updated configuration information, and the source network entity 105 may reconfigure the UE 115. For example, the new source network entity 105 may communicate the change in source network entity 105 to one or more candidate network entities 105, one or more candidate network entities 105 may indicate configuration information updates to one or more other candidate network entities 105, an anchor network entity 105 may forward information between candidate network entities 105, or a combination thereof.

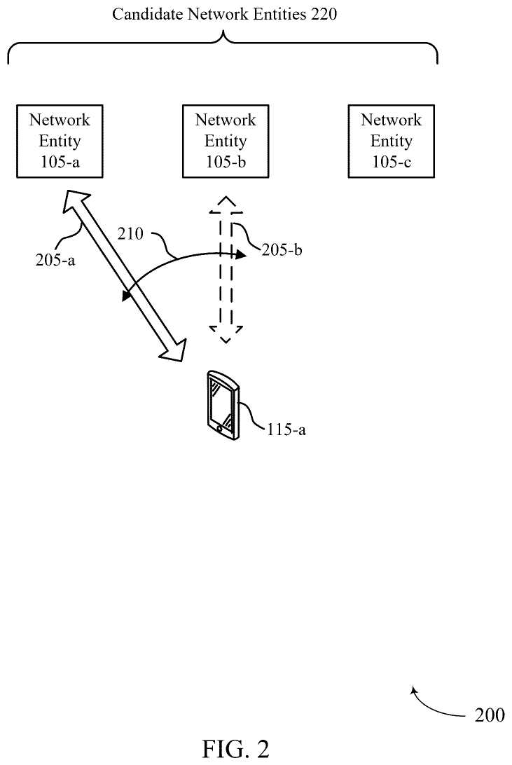

FIG. 2 shows an example of a wireless communications system 200 that supports resolving ambiguity of UE serving location in mobility procedures in accordance with one or more aspects of the present disclosure. The wireless communications system 200 describes the communications between candidate network entities 220 and a UE 115-a. The candidate network entities 220 may include a network entity 105-a, a network entity 105-b, and a network entity 105-c, which may be examples of the network entity 105 as described with reference to FIG. 1. The UE 115-a may be an example of the UE 115 as described with reference to FIG. 1.

As described herein, the candidate network entities 220 may include more than the quantity of network entities 105 described (e.g., there may be 4, 5, 6, etc.). The labels ‘candidate’, ‘source’, and ‘anchor’, among other descriptors, of the network entities 105 serve to clarify function, and are not limiting. For example, any of the candidate network entities 220 may be source network entities.

The candidate network entities 220 may communicate with the UE 115-a via a communication link 205 (e.g., communication link 205-a, communication link 205-b). In some examples, the network entity 105-a may communicate with the UE 115-a via the communication link 205-a and the network entity 105-b may communicate with the UE 115-a via the communication link 205-b. The UE 115-a may stop communicating with the network entity 105-a and begin communications (e.g., a communications session) with the network entity 105-b. The movement, or transfer, at 210 may be an example of a mobility procedure, such as an LTM procedure.

The UE 115-a may transfer, or move, communications from one network entity 105 to another. Procedures for transferring communications include conditional handover and LTM. Conditional handover may have various limitations, such as restricting mobility between cells of the same network entity 105 (e.g., intra-gNB restrictions, where a gNB may include a CU and one or more DUs) and restricting measurements for handover to specific resources. Improving the mobility between network entities 105 (e.g., cells) may be advantageous, including supporting inter-gNB or inter-CU mobility procedures.

In some conditional handover applications, the UE 115-a may be communicating with, or being served by, the network entity 105-a and be configured with the network entity 105-b and the network entity 105-c as conditional handover candidates. In some examples, each network entity 105-a may include one or more cells, such that the UE 115-a may be served by a first cell of the network entity 105-a.

Each network entity 105 may be configured with mobility procedure information, such as conditional handover information, for the UE 115-a . The mobility configuration information may indicate that each network entity 105 is one of the candidate network entities 220. In some examples, the configuration information may become outdated, or inaccurate. For example, the UE 115-a may be configured to perform a conditional handover procedure to move communications from a source network entity 105-a to the network entity 105-b, which may be the new source network entity 105. In some examples, the mobility configuration information of the candidate network entities, such as the network entity 105-c, may become outdated. If the mobility configuration information for the network entity 105-c becomes outdated in conditional handover, the network entity 105-c may follow steps to notify the source network entity 105-a of the update.

In a first scenario, if the conditional handover procedure has not been triggered, the network entity 105-c may transmit (e.g., send) a notification to the network entity 105-a, which is the source network entity 105-a. In another scenario, if the conditional handover has been triggered, the network entity 105-b is the serving cell, and the network entity 105-c has not been updated to the change. In such an example, the UE 115-a may delete all conditional handover configurations for all the candidate network entities 220, and the network entity 105-a, having participated in the conditional handover procedure, may indicate a message to the network entity 105-c to remove (e.g., cancel, delete) the configuration information. In such examples, the network entities 105 either have updated configuration information, or are notified when the information is outdated.

Another handover procedure may be an LTM procedure. For example, the candidate network entities 220 may be configured as candidates for an LTM procedure of the UE 115-a . The network entity 105-a may be the source network entity communicating with the UE 115-a . The UE 115-a may be configured to execute an LTM procedure to transfer communications between the candidate network entities 220, such as from the network entity 105-a to the network entity 105-b.

In some examples, the configuration of the network entity 105-c may become outdated. To inform the UE 115-a of the outdated configuration of the UE 115-a , the UE 115-a may receive RRC signaling from the source network entity 105-a currently serving the UE 115-a . In some examples, the network entity 105-c may not have the updated serving location of the UE 115-a , and thus may not be able to notify the network entity 105-a to notify the UE 115-a of the outdated configuration.

Techniques described herein provide for signaling and procedure for LTM candidate network entities 220 to communicate indications of outdated configurations, and resolve ambiguity of UE location (e.g., which network entity is serving the UE at a particular time) information. Such techniques may reduce overhead signaling and delay.

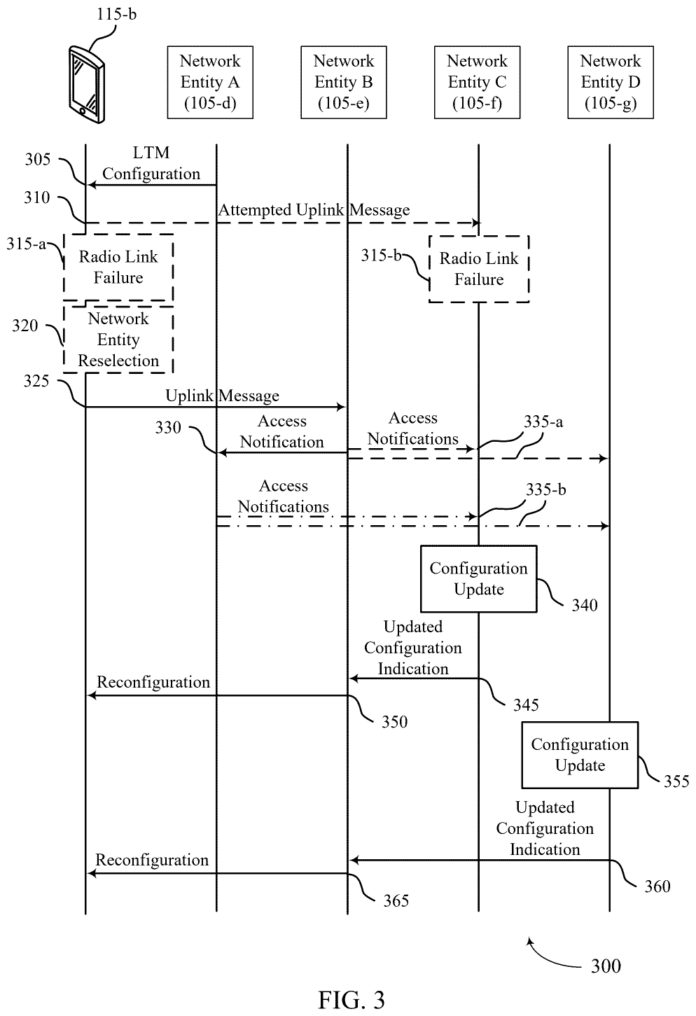

In some examples, to resolve ambiguity of the UE serving location for LTM applications, the candidate network entities 220 may be notified of the UE 115-a serving location change (e.g., the UE 115-a was handed over from the network entity 105-a to the network entity 105-b). In some examples, any candidate network entity 220 with outdated configuration information may notify all other candidate network entities 220, regardless of UE 115-a location. In some examples, a network entity 105 may be configured as an anchor network entity 105, and may receive and forward notifications of outdated configurations between candidate network entities 220. Signaling and techniques are further described with reference to FIGS. 3-7.

FIG. 3 shows an example of a process flow diagram 300 that supports resolving ambiguity of UE serving location in mobility procedures in accordance with one or more aspects of the present disclosure. The process flow diagram 300 describes notification of updated LTM configuration information between network entities 105. The UE 115-b may communicate with candidate network entities, such as a network entity A (e.g., a network entity 105-d), a network entity B (e.g., a network entity 105-e), a network entity C (e.g., a network entity 105-f), and a network entity D (e.g., a network entity 105-g). The network entities 105 may be examples of the network entities 105 as described with reference to FIG. 1 or FIG. 2. The UE 115-b may be an example of the UE 115 and the UE 115-a as described with reference to FIG. 1 or FIG. 2, respectively. In the following description of the process flow diagram 300, the operations may be performed in different orders or at different times. Some operations may be left out and other operations may be added. Some aspects of some operations may be performed by one or more other wireless devices.

The network entity A, the network entity B, the network entity C, and the network entity D may be examples of candidate network entities configured for an LTM procedure. A candidate network entity may indicate to be the source network entity. For example, as described with reference to FIG. 3, the network entity A may be the source network entity A with respect to UE 115-b. The UE 115-b may complete an LTM procedure to move communications from the source network entity A (e.g., the original source) to a new source, such as the network entity B. The network entity C and the network entity D may be candidate network entities configured for LTM procedures with the UE 115-b. In some examples, such as described with reference to FIG. 3, the network entities C and D may not be selected to be source network entities for the UE 115-b.

To address the ambiguity of the UE 115-b location, the new source network entity B may, after the LTM procedure, transmit (e.g., output) one or more access notifications. In some examples, the new source network entity B may transmit the access notifications to the network entities A, C, and D. In some examples, the new source network entity B may transmit an access notification to the original source network entity A, and the network entity A may forward the access notification to the candidate network entities C and D. In some examples, prior to a successful LTM procedure transferring communications from the original source network entity A to the new source network entity B, the UE 115-b may attempt and fail an LTM procedure to with a different candidate network entity, such as the network entity C (e.g., as described with reference to steps 310-320).

At 305, the network entity A may be configured as the original source network entity A communicating with UE 115-b. The original source network entity A may transmit an LTM configuration to the UE 115-b. The LTM configuration information may indicate to the UE 115-b to perform an LTM procedure to transfer a communication session from one network entity to another, such as from the network entity A to the network entity B, or from the network entity A to the network entity C.

At 310, in some examples, the UE 115-b may attempt transmit an uplink message to the network entity C. For example, the LTM configuration may have indicated for the UE 115-b to transfer to the network entity C. The attempted uplink message may be unsuccessful.

At 315-a and 315-b, the message failure may cause radio link failure at the UE 115-b and the network entity C. In such examples, at 320, the UE 115-b may complete network entity reselection. Although radio link failure is provided as an example, the unsuccessful attempt to transfer communications to network entity C may be an example of any type of mobility procedure other than a successful LTM transfer procedure.

At 325, the UE 115-b may transmit an uplink message (e.g., indication) to the network entity B (e.g., a first source network entity). The uplink message may be an indication from the UE 115-b that the LTM procedure has occurred, where the LTM procedure includes the UE 115-b transferring a communication session from the original source network entity A (e.g., a second source network entity) to the new source network entity B.

In some examples, the network entity B may receive the uplink message, or indication, from the UE 115-b based on a prior mobility procedure other than a successful LTM procedure. A prior mobility procedure may include a layer 3 mobility procedure or an LTM procedure with radio link failure. For example, the uplink message may be received in response to radio link failure and network entity reselection (e.g., as described with reference to steps 3103-20). In some examples, there may not be a procedure prior to the LTM procedure, such as if the LTM configuration indicates to the UE 115-b to move to the new source network entity B and the procedure is successful.

At 330, the new source network entity B may indicate (e.g., transmit, output) an access notification (e.g., a first access notification) to the original source network entity A. The access notification may indicate successful transfer of the communication with the UE 115-b to the new source network entity B.

At 335, either the original source network entity A or the new source network entity B may transmit access notifications to the candidate network entities C and D. In some examples, at 335-a, the network entity B transmits the access notifications to the network entities C and D (e.g., one or more second access notifications). The access notifications to the candidate network entities C and D may indicate that the network entity B is the new source (e.g., serving) network entity of the UE 115-b. The access notifications to the candidate network entities C and D may be sent simultaneously with the access notification to the network entity A. The network entity B may transmit the access notifications to the network entity A, the network entities C and D, or both, based on receiving the uplink message transferring the communication session of the UE 115-b.

In some examples, at 335-b, the access notification indicating the network entity B is the source network entity may be indirectly communicated to the candidate network entities C and D. For example, instead of the new source network entity B transmitting the access notifications, the original network entity A may transmit, or forward, the access notifications to the network entities C and D based on receiving the access notification from the network entity B. In such examples, as the network entity A is acting as an intermediate by forwarding the access notification from the network entity B to the network entities C and D, and the network entity A may be an example of an anchor network entity.

At 340, the network entity C may have, or otherwise recognize, a configuration update. For example, the network entity C may have outdated configuration information that is relevant to an LTM procedure for the UE 115-b.

At 345, the network entity C may indicate to the new source network entity B via an updated configuration indication that the LTM configuration information at the network entity C is outdated. The network entity B may receive the updated configuration indication based on the access notification (either from the network entity A or B) sent to the network entity C. As the access notification informs the network entity C that the network entity B is the source network entity, the network entity C then indicates any configuration changes to the new source network entity B, and not the original source network entity A. The access notifications remove ambiguity as to the location of the UE 115-b, and enable the network entity C to transmit updated configuration information to the current source network entity B.

At 350, the network entity B may transmit a reconfiguration message, such as an RRC reconfiguration message, to the UE 115-b based on the indicated updated configuration from the network entity C.

At 355, the network entity D, similarly to the network entity C, may have, or otherwise recognize, a configuration update of outdated configuration information.

At 360, the network entity D may indicate to the new source network entity B via an updated configuration indication that the configuration information at the network entity D is outdated. The network entity B may receive the updated configuration indication based on the access notification.

At 365, the network entity B may transmit a configuration, such as an RRC reconfiguration message, to the UE 115-b based on the indicated updated configuration from the network entity D.

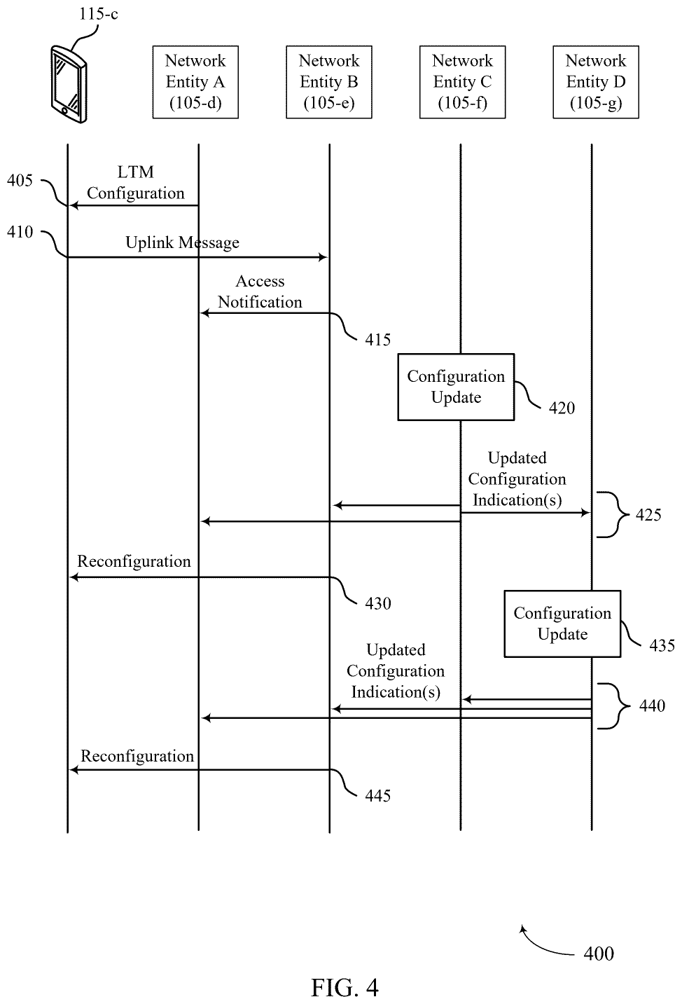

FIG. 4 shows an example of a process flow diagram 400 that supports resolving ambiguity of UE serving location in mobility procedures in accordance with one or more aspects of the present disclosure. The process flow diagram 400 describes communication of updated configurations for LTM procedures. The UE 115-c may communicate with candidate network entities, such as a network entity A (e.g., a network entity 105-d), a network entity B (e.g., a network entity 105-e), a network entity C (e.g., a network entity 105-f), and a network entity D (e.g., a network entity 105-g). The network entities 105 may be examples of the network entities 105 as described with reference to any of FIG. 1 through FIG. 3. The UE 115-c may be an example of any of the UEs 115 as described with reference to any of FIG. 1 through FIG. 3. In the following description of the process flow diagram 400, the operations may be performed in different orders or at different times. Some operations may be left out and other operations may be added. Some aspects of some operations may be performed by one or more other wireless devices.

The network entities A, B, C, and D may be configured for an LTM procedure for the UE 115-c. In some examples, each of the network entities may obtain (e.g., receive) an indication of a configuration indicating that each network entity is one of one or more candidate network entities configured for an LTM procedure for the UE 115-c. For example, the network entity C (e.g., a first network entity) may receive the indication of the configuration indicating that the network entity C is one of the candidate network entities. The UE 115-c may transfer communications from the network entity A to the network entity B according to the LTM procedure. The candidate network entities C and D may transmit messages to the other network entities when there is a configuration update (e.g., outdated configuration information).

At 405, the network entity A may be the original source network entity A communicating with UE 115-b. The original source network entity A may transmit an LTM configuration to the UE 115-c. The LTM configuration information may indicate to the UE 115-c to move a communication session from one network entity to another, such as from the network entity A to the network entity B.

At 410, the UE 115-b may transmit an uplink message to the network entity B. The uplink message may be an indication from the UE 115-c that the LTM procedure has occurred, where the LTM procedure includes the UE 115-c transferring a communication session from the network entity A to the network entity B.

At 415, the new source network entity B may indicate (e.g., transmit, output) an access notification (e.g., a first access notification) to the original source network entity A. The access notification may indicate successful transfer of the communication to the new source network entity B.

At 420, the network entity C may update LTM procedure information associated with the LTM procedure previously configured. For example, the network entity may have outdated configuration information.

At 425, the network entity C may output one or more updated configuration indications to at least one of the one or more candidate network entities based on updating the LTM procedure information. For example, the network entity C may transmit updated configuration indications to the network entities A, B, and D indicating that the network entity C has outdated configuration information. In some examples, the updated configuration indications may be broadcast to the other network entities. In such an example, the network entity C does not target the notification to the source network entity B, as the LTM procedure has been completed and network entity C has not been updated to the change in location of the UE 115-c.

At 430, the network entity B may transmit a reconfiguration, such as an RRC reconfiguration message, to the UE 115-c based on the indicated updated configuration from the network entity C. The network entity B transmits the reconfiguration based on being the source network entity for the UE 115-c.

At 435, similarly to the network entity C, the network entity D may be a candidate network entity. The network entity D may update LTM procedure information associated with the LTM procedure previously configured. For example, the network entity may have outdated configuration information.

At 440, the network entity D may output one or more updated configuration indications to at least one of the one or more candidate network entities based on updating the LTM procedure information. For example, the network entity D may transmit updated configuration indications to the network entities A, B, and C indicating that the network entity D has outdated configuration information. In some examples, the updated configuration indications may be broadcast to the other network entities.

At 445, the network entity B may transmit a reconfiguration, such as an RRC reconfiguration message, to the UE 115-c based on the indicated updated configuration from the network entity D.

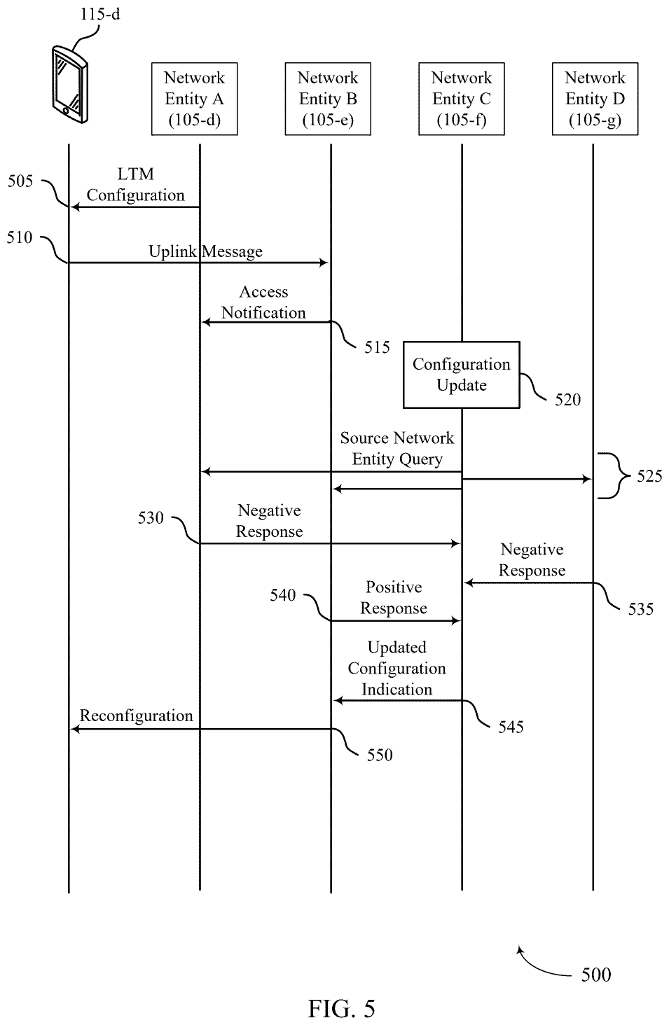

FIG. 5 shows an example of a process flow diagram 500 that supports resolving ambiguity of UE serving location in mobility procedures in accordance with one or more aspects of the present disclosure. The process flow diagram 500 describes communication of updated configurations for LTM procedures. The UE 115-d may communicate with candidate network entities, such as a network entity A (e.g., a network entity 105-d), a network entity B (e.g., a network entity 105-e), a network entity C (e.g., a network entity 105-f), and a network entity D (e.g., a network entity 105-g). The network entities 105 may be examples of the network entities 105 as described with reference to any of FIG. 1 through FIG. 4. The UE 115-d may be an example of the UEs 115 as described with reference to any of FIG. 1 through FIG. 4. In the following description of the process flow diagram 500, the operations may be performed in different orders or at different times. Some operations may be left out and other operations may be added. Some aspects of some operations may be performed by one or more other wireless devices.

The network entities A, B, C, and D may be configured for an LTM procedure for the UE 115-d. In some examples, each of the network entities may obtain (e.g., receive) an indication of a configuration indicating that each network entity is one of one or more candidate network entities configured for an LTM procedure for the UE 115-d. For example, the network entity C (e.g., a first network entity) may receive the indication of the configuration indicated that the network entity C is one of the candidate network entities.

As described with reference to FIG. 5, the UE 115-d may complete an LTM procedure and transfer a communication session from the network entity A to the network entity B. The network entity C, without receiving notification of the LTM procedure, may have a configuration update and query the other network entities to locate the source network entity. The network entity C may receive a positive response form the network entity B indicating that network entity B is the source network entity. The network entity may then transmit an updated configuration indication to the source network entity B. By querying before transmitting the updated configuration indication, the network entity C only notifies the source network entity B, which may then reconfigure the UE 115-d.

At 505, the network entity A may be the original source network entity A communicating with UE 115-b. The original source network entity A may transmit an LTM configuration to the UE 115-c. The LTM configuration information may indicate to the UE 115-c to move a communication session from one network entity to another, such as from the network entity A to the network entity B.

At 510, the UE 115-b may transmit an uplink message to the network entity B. The uplink message may be an indication from the UE that the LTM procedure has occurred, where the LTM procedure includes the UE transferring a communication session from the network entity A to the network entity B.

At 515, the new source network entity B may indicate (e.g., transmit, output) an access notification (e.g., a first access notification) to the original source network entity A. The access notification may indicate successful transfer of the communication to the new source network entity B.

At 520, the network entity C may update LTM procedure information associated with the LTM procedure previously configured. For example, the network entity C may have outdated configuration information.

At 525, the network entity C may output (e.g., transmit) a query to the one or more candidate network entities (e.g., the network entities A, B, and D) including a request for an indication of whether the receiving network entity is a source network entity for the UE 115-d.

At 530, 535, and 540, the network entity C may obtain (e.g., receive) response messages from the network entities A, B, and D. The response messages may indicate whether the receiving network entity is the source network entity. For example, at 530, the network entity A may indicate a negative response that the network entity A is not the source network entity. At 535, the network entity D may indicate a negative response that the network entity D is not the source network entity. At 540, the network entity B may indicate a positive response that the network entity B is the source network entity.

At 545, the network entity C may output an updated configuration indication (e.g., a unicast message) to the source network entity B based on the response messages indicating that the source network entity B is the source network entity for the UE 115-d.

At 550, the network entity B may transmit a reconfiguration, such as an RRC reconfiguration message, to the UE 115-d based on the indicated updated configuration from the network entity C. The network entity B transmits the reconfiguration based on being the source network entity for the UE 115-d.

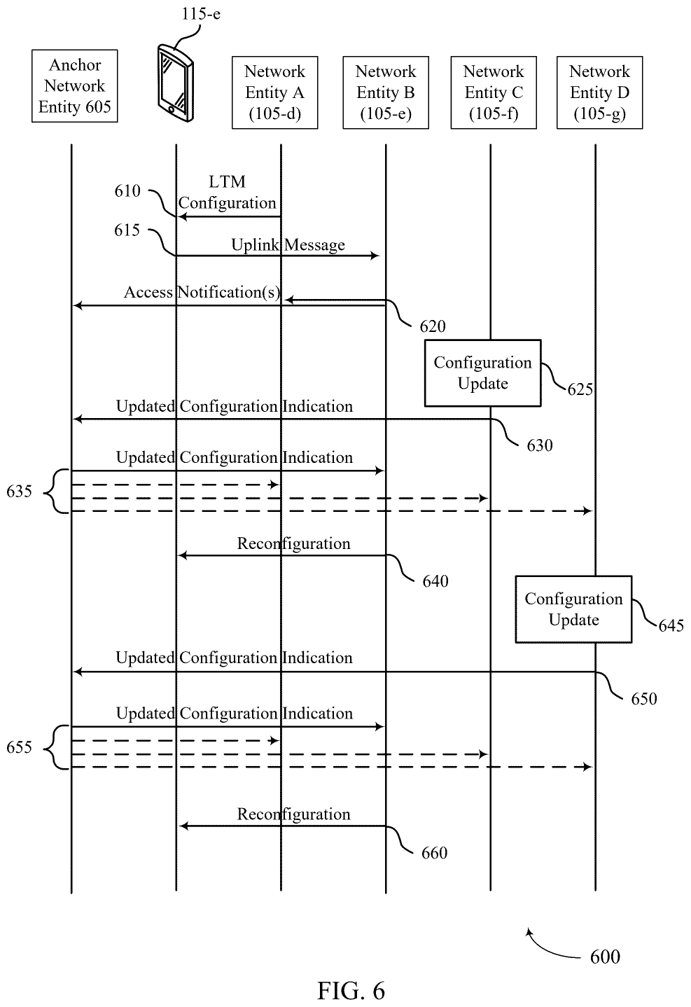

FIG. 6 shows an example of a process flow diagram 600 that supports resolving ambiguity of UE serving location in mobility procedures in accordance with one or more aspects of the present disclosure. The process flow diagram 600 describes forwarding of updated configurations for LTM procedures via an anchor network entity 605. The UE 115-c may communicate with candidate network entities, such as a network entity A (e.g., a network entity 105-d), a network entity B (e.g., a network entity 105-e), a network entity C (e.g., a network entity 105-f), and a network entity D (e.g., a network entity 105-g). In some examples, the anchor network entity 605 may be referred to as a candidate network entity. The network entities 105 and the anchor network entity 605 may be examples of the network entities 105 as described with reference to FIG. 1 through FIG. 5. The UE 115-e may be an example of the UE 115-a as described with reference to FIG. 2, or the UE 115 as described with reference to FIG. 1 through FIG. 5. In the following description of the process flow diagram 600, the operations may be performed in different orders or at different times. Some operations may be left out and other operations may be added. Some aspects of some operations may be performed by one or more other wireless devices.

As described with reference to FIG. 6, the UE 115-e may complete an LTM procedure, switching from the original source network entity A to the new source network entity B. The network entity B may notify both the network entity A and the anchor network entity 605 of the successful LTM procedure. The network entities C and D may not be updated, and may transmit their own respective configuration updates to the anchor network entity 605. The anchor network entity may then forward the updated configuration indications to the source network entity B, multiple of the network entities, or all of the candidate network entities.

The network entities A, B, C, and D may receive indication of configurations indicating each network entity is a candidate network entity configured for an LTM procedure for the UE 115-e. The anchor network entity 605 may receive (obtain) an indication (e.g., first indication) of a configuration indicating the anchor network entity 605 is a communication anchor for the one or more candidate network entities A, B, C, and D configured for an LTM procedure.

At 610, the network entity A may be the original source network entity A communicating with UE 115-e. The original source network entity A may transmit an LTM configuration to the UE 115-e. The LTM configuration information may indicate to the UE 115-e to move a communication session from one network entity to another, such as from the network entity A to the network entity B.

At 615, the UE 115-e may transmit an uplink message to the network entity B. The uplink message may be an indication from the UE 115-e that the LTM procedure has occurred, where the LTM procedure includes the UE 115-e transferring a communication session from the network entity A (e.g., a second source network entity) to the network entity B.

At 620, the new source network entity B may indicate (e.g., transmit, output) an access notification (e.g., a first access notification) to the original source network entity A, the anchor network entity 605, or both. The access notification may indicate successful transfer of the communication to the new source network entity B.

At 625, the network entity C may update LTM procedure information associated with the LTM procedure previously configured. For example, the network entity C may have outdated configuration information.

At 630, the network entity C may output (e.g., transmit) an updated configuration indication to the anchor network entity 605 based on the anchor network entity 605 being configured as the anchor network entity 605.

At 635, the anchor network entity 605 may forward (e.g., output) one or more updated configuration indications to one or more of the candidate network entities A, B, C, and D. The anchor network entity 605 may forward the updated configuration indications based on the access notification from the network entity B, the updated configuration indication from the network entity C, or both. For example, the anchor network entity 605 may only forward the updated configuration indication to the source network entity B. In some examples, the anchor network entity 605 may forward, or broadcast, the updated configuration indications to all or a combination of the candidate network entities A, B, C, and D.

At 640, the network entity B may transmit a reconfiguration, such as an RRC reconfiguration message, to the UE 115-e based on the indicated updated configuration from the network entity C. The network entity B transmits the reconfiguration based on being the source network entity for the UE 115-e.

At 645, the network entity D may update LTM procedure information associated with the LTM procedure previously configured. For example, the network entity D may have outdated configuration information.

At 650, the network entity D may output (e.g., transmit) an updated configuration indication to the anchor network entity 605 based on the anchor network entity 605 being configured as the anchor network entity 605.

At 655, the anchor network entity 605 may forward (e.g., output) one or more updated configuration indications to one or more of the candidate network entities A, B, C, and D. The anchor network entity 605 may forward the updated configuration indications based on the access notification from the network entity B, the updated configuration indication from the network entity D, the updated configuration indication from the network entity C, or a combination thereof. For example, the anchor network entity 605 may only forward the updated configuration indication to the source network entity B. In some examples, the anchor network entity 605 may forward, or broadcast, the updated configuration indications to all or a combination of the candidate network entities A, B, C, and D.

At 660, the network entity B may transmit a reconfiguration, such as an RRC reconfiguration message, to the UE 115-e based on the indicated updated configuration from the anchor network entity 605.

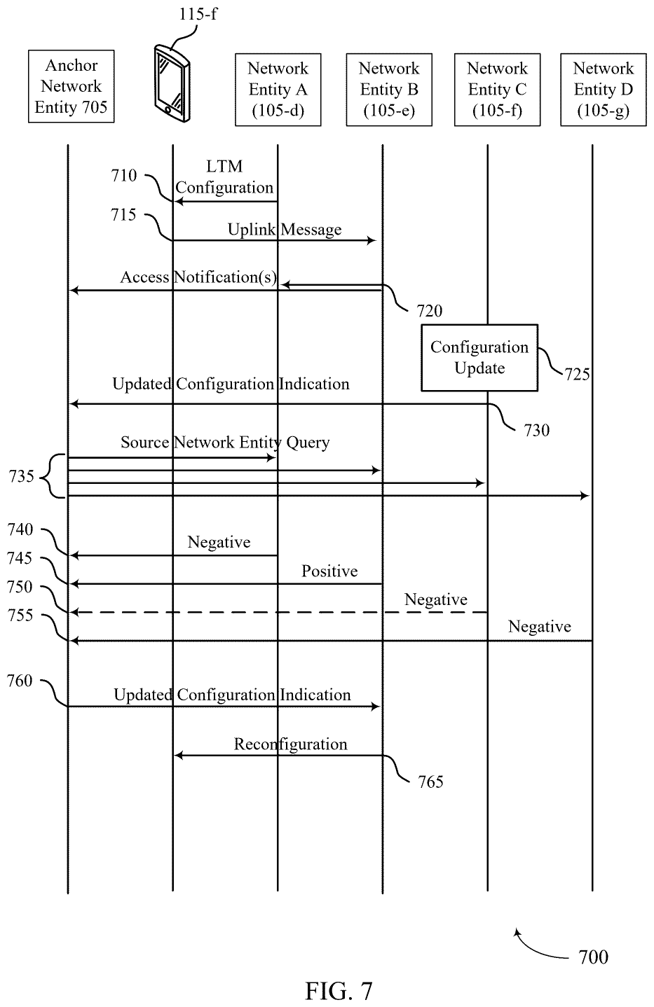

FIG. 7 shows an example of a process flow diagram 700 that supports resolving ambiguity of UE serving location in mobility procedures in accordance with one or more aspects of the present disclosure. The process flow diagram 700 describes forwarding of updated configurations for LTM procedures via an anchor network entity 705 based on a query from the anchor network entity 705. The UE 115-e may communicate with candidate network entities, such as a network entity A (e.g., a network entity 105-d), a network entity B (e.g., a network entity 105-e), a network entity C (e.g., a network entity 105-f), and a network entity D (e.g., a network entity 105-g). In some examples, the anchor network entity 705 may be referred to as a candidate network entity.

The network entities 105 and the anchor network entity 705 may be examples of the network entities 105 as described with reference to FIG. 1 through FIG. 6. The anchor network entity 705 may be an example of the anchor network entity 605 as described with reference to FIG. 6. The UE 115-f may be an example of the UEs 115 as described with reference to FIG. 1 through FIG. 6. In the following description of the process flow diagram 700, the operations may be performed in different orders or at different times. Some operations may be left out and other operations may be added. Some aspects of some operations may be performed by one or more other wireless devices.

As described with reference to FIG. 7, the UE 115-f may complete an LTM procedure, switching from the original source network entity A to the new source network entity B. The network entity B may notify both the network entity A and the anchor network entity 705 of the successful LTM procedure. The network entities C and D may not be updated. The network entity C may transmit a configuration update to the anchor network entity 705. The anchor network entity 705 may then query the candidate network entities to identify the source network entity B, and then forward the updated configuration indication to the source network entity B.

The network entities A, B, C, and D may receive indication of configurations indicating each network entity is a candidate network entity configured for an LTM procedure for the UE 115-f. The anchor network entity 705 may receive (obtain) an indication (e.g., first indication) of a configuration indicating the anchor network entity 705 is a communication anchor for the one or more candidate network entities A, B, C, and D configured for an LTM procedure.

At 710, the network entity A may be the original source network entity A communicating with UE 115-f. The original source network entity A may transmit an LTM configuration to the UE 115-f. The LTM configuration information may indicate to the UE 115-f to move a communication session from one network entity to another, such as from the network entity A to the network entity B.

At 715, the UE 115-f may transmit an uplink message to the network entity B. The uplink message may be an indication from the UE 115-f that the LTM procedure has occurred, where the LTM procedure includes the UE 115-f transferring a communication session from the network entity A to the new source network entity B.

At 720, the source network entity B may indicate (e.g., transmit, output) an access notification (e.g., a first access notification) to the original source network entity A, the anchor network entity 705, or both. The access notification may indicate successful transfer of the communication to the new source network entity B.

At 725, the network entity C may update LTM procedure information associated with the LTM procedure previously configured. For example, the network entity C may have outdated configuration information.

At 730, the network entity C may output (e.g., transmit) an updated configuration indication to the anchor network entity 705 based on the anchor network entity 705 being configured as the anchor network entity 705.

At 735, the anchor network entity 705 may output (e.g., transmit) a query to the one or more candidate network entities (e.g., the network entities A, B, C, and D) including a request for an indication of whether the receiving network entity is a source network entity for the UE 115-e.

At 740, 745, 750, and 755, the anchor network entity 705 may obtain (e.g., receive) response messages from the network entities A, B, C, and D. The response messages may indicate whether the receiving network entity is the source network entity. For example, at 740, the network entity A may indicate a negative response, that the network entity A is not the source network entity. At 745, the network entity B may indicate a positive response, that the network entity B is the source network entity. At 750, the network entity C may indicate a negative response, that the network entity C is not the source network entity. In some examples, the network entity C may not respond to the query, as the network entity C transmitted the updated configuration indication inditing outdated configuration information, which may implicitly or explicitly indicate that the network entity C is not the source network entity. At 755, the network entity D may indicate a negative response, that the network entity D is not the source network entity.

At 760, the anchor network entity 705 may output one updated configuration indication (e.g., a unicast message) to the source network entity B based on the response messages indicating that the source network entity B is the source network entity for the UE 115-f.

At 765, the network entity B may transmit a reconfiguration, such as an RRC reconfiguration message, to the UE 115-f based on the indicated updated configuration from the anchor network entity 705. The network entity B transmits the reconfiguration based on being the source network entity for the UE 115-f.

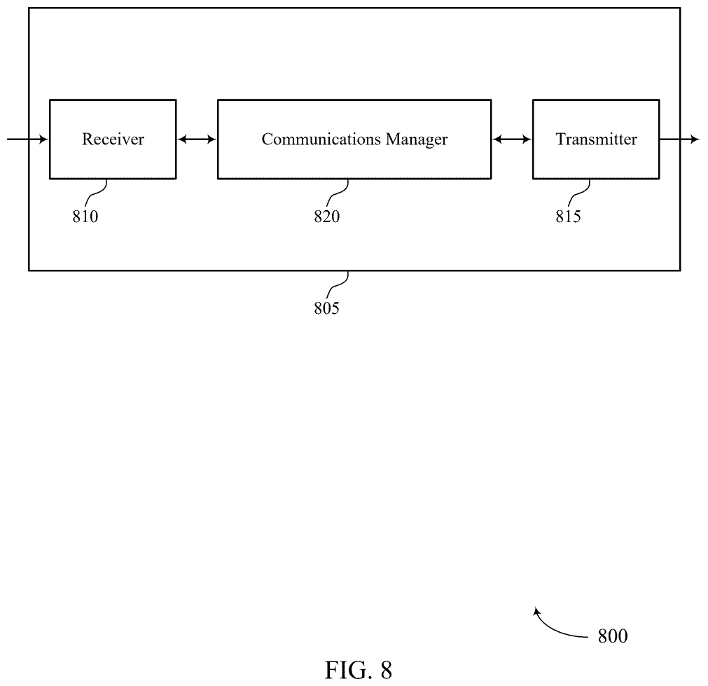

FIG. 8 shows a block diagram 800 of a device 805 that supports resolving ambiguity of UE serving location in mobility procedures in accordance with one or more aspects of the present disclosure. The device 805 may be an example of aspects of a network entity 105 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to, individually or collectively, support or enable the described techniques. Each of these components may be in communication with one another (e.g., via one or more buses).

The receiver 810 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 805. In some examples, the receiver 810 may support obtaining information by receiving signals via one or more antennas. Additionally, or alternatively, the receiver 810 may support obtaining information by receiving signals via one or more wired (e.g., electrical, fiber optic) interfaces, wireless interfaces, or any combination thereof.

The transmitter 815 may provide a means for outputting (e.g., transmitting, providing, conveying, sending) information generated by other components of the device 805. For example, the transmitter 815 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 815 may support outputting information by transmitting signals via one or more antennas. Additionally, or alternatively, the transmitter 815 may support outputting information by transmitting signals via one or more wired (e.g., electrical, fiber optic) interfaces, wireless interfaces, or any combination thereof. In some examples, the transmitter 815 and the receiver 810 may be co-located in a transceiver, which may include or be coupled with a modem.

The communications manager 820, the receiver 810, the transmitter 815, or various combinations or components thereof may be examples of means for performing various aspects of resolving ambiguity of UE serving location in mobility procedures as described herein. For example, the communications manager 820, the receiver 810, the transmitter 815, or various combinations or components thereof may be capable of performing one or more of the functions described herein.

In some examples, the communications manager 820, the receiver 810, the transmitter 815, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 820, the receiver 810, the transmitter 815, or various combinations or components thereof may be implemented in code (e.g., as communications management software or firmware) executed by at least one processor (e.g., referred to as a processor-executable code). If implemented in code executed by at least one processor, the functions of the communications manager 820, the receiver 810, the transmitter 815, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 820 may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. For example, the communications manager 820 is capable of, configured to, or operable to support a means for obtaining an indication from a UE that an LTM procedure has occurred, where the LTM procedure includes the UE transferring a communication session from a second source network entity to the first source network entity. The communications manager 820 is capable of, configured to, or operable to support a means for outputting, based on the UE transferring the communication session, one or more access notifications to one or more candidate network entities. The communications manager 820 is capable of, configured to, or operable to support a means for obtaining, from at least one of the one or more candidate network entities, one or more updated configuration indications based on the one or more access notifications, where the one or more updated configuration indications indicate updated LTM procedure information at one or more of the one or more candidate network entities.

Additionally, or alternatively, the communications manager 820 may support wireless communications in accordance with examples as disclosed herein. For example, the communications manager 820 is capable of, configured to, or operable to support a means for obtaining a first indication of a configuration indicating the first network entity is one of one or more candidate network entities configured for an LTM procedure for a UE. The communications manager 820 is capable of, configured to, or operable to support a means for updating LTM procedure information associated with the LTM procedure. The communications manager 820 is capable of, configured to, or operable to support a means for outputting one or more updated configuration indications to at least one of the one or more candidate network entities based on updating the LTM procedure information.

Additionally, or alternatively, the communications manager 820 may support wireless communications in accordance with examples as disclosed herein. For example, the communications manager 820 is capable of, configured to, or operable to support a means for obtaining a first indication of a configuration indicating the anchor network entity is a communication anchor for one or more candidate network entities configured for an LTM procedure for a UE. The communications manager 820 is capable of, configured to, or operable to support a means for obtaining one or more updated configuration indications from at least one candidate network entity of the one or more candidate network entities based on the first indication of the configuration indicating the anchor network entity being configured as the communication anchor. The communications manager 820 is capable of, configured to, or operable to support a means for forwarding, based at least in part on obtaining the one or more updated configuration indications from the at least one candidate network entity, the one or more updated configuration indications to the one or more candidate network entities.

By including or configuring the communications manager 820 in accordance with examples as described herein, the device 805 (e.g., at least one processor controlling or otherwise coupled with the receiver 810, the transmitter 815, the communications manager 820, or a combination thereof) may support techniques for resolving ambiguity of UE location, which may result in various advantages, such as reduced processing, reduced power consumption, more efficient utilization of communication resources, etc.

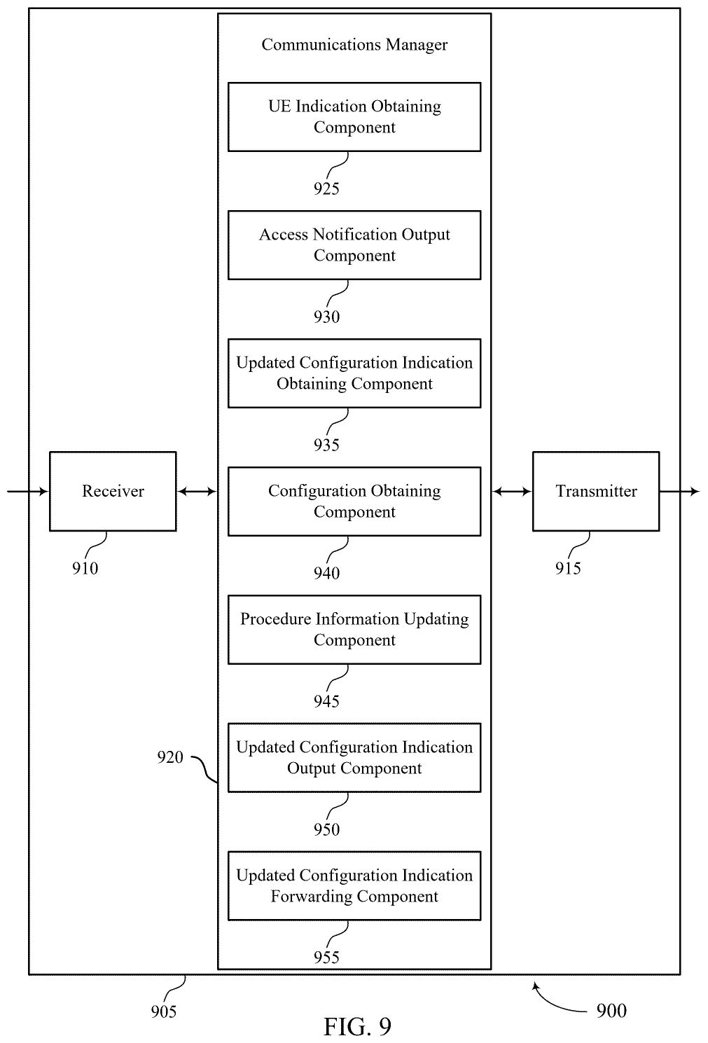

FIG. 9 shows a block diagram 900 of a device 905 that supports resolving ambiguity of UE serving location in mobility procedures in accordance with one or more aspects of the present disclosure. The device 905 may be an example of aspects of a device 805 or a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The device 905, or various components thereof, may be an example of means for performing various aspects of resolving ambiguity of UE serving location in mobility procedures as described herein. For example, the communications manager 920 may include a UE indication obtaining component 925, an access notification output component 930, an updated configuration indication obtaining component 935, a configuration obtaining component 940, a procedure information updating component 945, an updated configuration indication output component 950, an updated configuration indication forwarding component 955, or any combination thereof. The communications manager 920 may be an example of aspects of a communications manager 820 as described herein. In some examples, the communications manager 920, or various components thereof, may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications in accordance with examples as disclosed herein. The UE indication obtaining component 925 is capable of, configured to, or operable to support a means for obtaining an indication from a UE that an LTM procedure has occurred, where the LTM procedure includes the UE transferring a communication session from a second source network entity to the first source network entity. The access notification output component 930 is capable of, configured to, or operable to support a means for outputting, based on the UE transferring the communication session, one or more access notifications to one or more candidate network entities. The updated configuration indication obtaining component 935 is capable of, configured to, or operable to support a means for obtaining, from at least one of the one or more candidate network entities, one or more updated configuration indications based on the one or more access notifications, where the one or more updated configuration indications indicate updated LTM procedure information at one or more of the one or more candidate network entities.

Additionally, or alternatively, the communications manager 920 may support wireless communications in accordance with examples as disclosed herein. The configuration obtaining component 940 is capable of, configured to, or operable to support a means for obtaining a first indication of a configuration indicating the first network entity is one of one or more candidate network entities configured for an LTM procedure for a UE. The procedure information updating component 945 is capable of, configured to, or operable to support a means for updating LTM procedure information associated with the LTM procedure. The updated configuration indication output component 950 is capable of, configured to, or operable to support a means for outputting one or more updated configuration indications to at least one of the one or more candidate network entities based on updating the LTM procedure information.

Additionally, or alternatively, the communications manager 920 may support wireless communications in accordance with examples as disclosed herein. The configuration obtaining component 940 is capable of, configured to, or operable to support a means for obtaining a first indication of a configuration indicating the anchor network entity is a communication anchor for one or more candidate network entities configured for an LTM procedure for a UE. The updated configuration indication obtaining component 935 is capable of, configured to, or operable to support a means for obtaining one or more updated configuration indications from at least one candidate network entity of the one or more candidate network entities based on the first indication of the configuration indicating the anchor network entity being configured as the communication anchor. The updated configuration indication forwarding component 955 is capable of, configured to, or operable to support a means for forwarding, based on obtaining the one or more updated configuration indications from the at least one candidate network entity, the one or more updated configuration indications to the one or more candidate network entities.

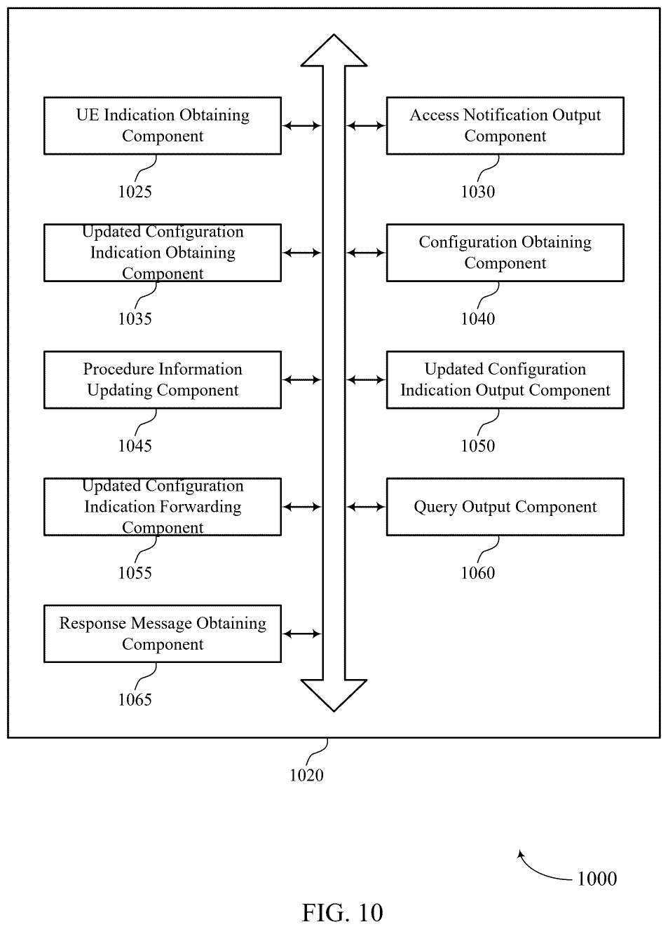

FIG. 10 shows a block diagram 1000 of a communications manager 1020 that supports resolving ambiguity of UE serving location in mobility procedures in accordance with one or more aspects of the present disclosure. The communications manager 1020 may be an example of aspects of a communications manager 820, a communications manager 920, or both, as described herein. The communications manager 1020, or various components thereof, may be an example of means for performing various aspects of resolving ambiguity of UE serving location in mobility procedures as described herein. For example, the communications manager 1020 may include a UE indication obtaining component 1025, an access notification output component 1030, an updated configuration indication obtaining component 1035, a configuration obtaining component 1040, a procedure information updating component 1045, an updated configuration indication output component 1050, an updated configuration indication forwarding component 1055, a query output component 1060, a response message obtaining component 1065, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1020 may support wireless communications in accordance with examples as disclosed herein. The UE indication obtaining component 1025 is capable of, configured to, or operable to support a means for obtaining an indication from a UE that an LTM procedure has occurred, where the LTM procedure includes the UE transferring a communication session from a second source network entity to the first source network entity. The access notification output component 1030 is capable of, configured to, or operable to support a means for outputting, based on the UE transferring the communication session, one or more access notifications to one or more candidate network entities. The updated configuration indication obtaining component 1035 is capable of, configured to, or operable to support a means for obtaining, from at least one of the one or more candidate network entities, one or more updated configuration indications based on the one or more access notifications, where the one or more updated configuration indications indicate updated LTM procedure information at one or more of the one or more candidate network entities.

In some examples, to support outputting the one or more access notifications, the access notification output component 1030 is capable of, configured to, or operable to support a means for outputting a first access notification to the second source network entity. In some examples, to support outputting the one or more access notifications, the access notification output component 1030 is capable of, configured to, or operable to support a means for outputting one or more second access notifications to one or more other network entities, where the first access notification indicates successful transfer of the communication session to the first source network entity and where the one or more second access notifications indicate that the first source network entity is a serving entity of the UE.

In some examples, to support outputting the one or more access notifications, the access notification output component 1030 is capable of, configured to, or operable to support a means for outputting a first access notification to the second source network entity, where obtaining the one or more updated configuration indications is further based on signaling transmitted, in response to the first access notification, from the second source network entity to one or more of the one or more candidate network entities.

In some examples, obtaining the indication from the UE is further based on a prior mobility procedure other than a successful LTM procedure.

Additionally, or alternatively, the communications manager 1020 may support wireless communications in accordance with examples as disclosed herein. The configuration obtaining component 1040 is capable of, configured to, or operable to support a means for obtaining a first indication of a configuration indicating the first network entity is one of one or more candidate network entities configured for an LTM procedure for a UE. The procedure information updating component 1045 is capable of, configured to, or operable to support a means for updating LTM procedure information associated with the LTM procedure. The updated configuration indication output component 1050 is capable of, configured to, or operable to support a means for outputting one or more updated configuration indications to at least one of the one or more candidate network entities based on updating the LTM procedure information.

In some examples, to support outputting the one or more updated configuration indications, the updated configuration indication output component 1050 is capable of, configured to, or operable to support a means for broadcasting the one or more updated configuration indications to the one or more candidate network entities.

In some examples, the query output component 1060 is capable of, configured to, or operable to support a means for outputting a query to the one or more candidate network entities including a request for an indication of whether a receiving candidate network entity of the one or more candidate network entities is a source network entity for the UE. In some examples, the response message obtaining component 1065 is capable of, configured to, or operable to support a means for obtaining one or more response messages from the one or more candidate network entities, where the one or more response messages indicate whether the receiving candidate network entity is the source network entity. In some examples, the updated configuration indication output component 1050 is capable of, configured to, or operable to support a means for outputting the one or more updated configuration indications to the source network entity based on the one or more response messages.

Additionally, or alternatively, the communications manager 1020 may support wireless communications in accordance with examples as disclosed herein. In some examples, the configuration obtaining component 1040 is capable of, configured to, or operable to support a means for obtaining a first indication of a configuration indicating the anchor network entity is a communication anchor for one or more candidate network entities configured for an LTM procedure for a UE. In some examples, the updated configuration indication obtaining component 1035 is capable of, configured to, or operable to support a means for obtaining one or more updated configuration indications from at least one candidate network entity of the one or more candidate network entities based on the first indication of the configuration indicating the anchor network entity being configured as the communication anchor. The updated configuration indication forwarding component 1055 is capable of, configured to, or operable to support a means for forwarding, based on obtaining the one or more updated configuration indications from the at least one candidate network entity, the one or more updated configuration indications to the one or more candidate network entities.

In some examples, to support forwarding the one or more updated configuration indications, the updated configuration indication forwarding component 1055 is capable of, configured to, or operable to support a means for forwarding the one or more updated configuration indications to a source network entity, where the source network entity is one of the one or more candidate network entities.

In some examples, to support forwarding the one or more updated configuration indications, the updated configuration indication forwarding component 1055 is capable of, configured to, or operable to support a means for broadcasting the one or more updated configuration indications to the one or more candidate network entities.

In some examples, the query output component 1060 is capable of, configured to, or operable to support a means for outputting a query to the one or more candidate network entities including a request for an indication of where a receiving candidate network entity of the one or more candidate network entities is a source network entity for the UE. In some examples, the response message obtaining component 1065 is capable of, configured to, or operable to support a means for obtaining one or more response messages from the one or more candidate network entities, where the one or more response messages indicate whether the receiving candidate network entity is the source network entity. In some examples, the updated configuration indication output component 1050 is capable of, configured to, or operable to support a means for outputting the one or more updated configuration indications to the source network entity based on the one or more response messages.

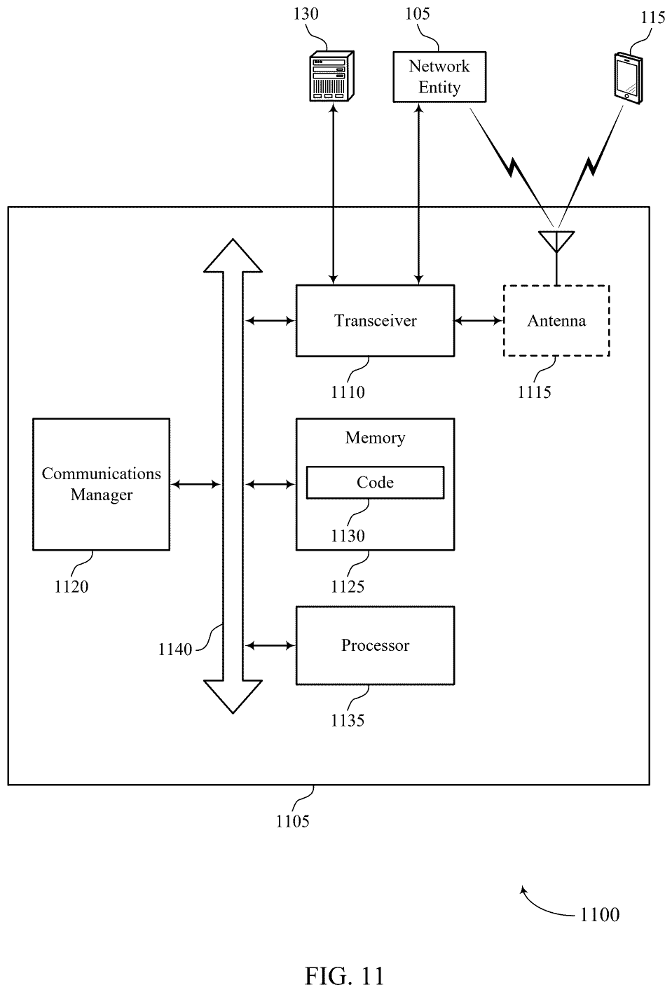

FIG. 11 shows a diagram of a system 1100 including a device 1105 that supports resolving ambiguity of UE serving location in mobility procedures in accordance with one or more aspects of the present disclosure. The device 1105 may be an example of or include components of a device 805, a device 905, or a network entity 105 as described herein. The device 1105 may communicate with other network devices or network equipment such as one or more of the network entities 105, UEs 115, or any combination thereof. The communications may include communications over one or more wired interfaces, over one or more wireless interfaces, or any combination thereof. The device 1105 may include components that support outputting and obtaining communications, such as a communications manager 1120, a transceiver 1110, one or more antennas 1115, at least one memory 1125, code 1130, and at least one processor 1135. These components may be in electronic communication or otherwise coupled (e.g., operatively, communicatively, functionally, electronically, electrically) via one or more buses (e.g., a bus 1140).

The transceiver 1110 may support bi-directional communications via wired links, wireless links, or both as described herein. In some examples, the transceiver 1110 may include a wired transceiver and may communicate bi-directionally with another wired transceiver. Additionally, or alternatively, in some examples, the transceiver 1110 may include a wireless transceiver and may communicate bi-directionally with another wireless transceiver. In some examples, the device 1105 may include one or more antennas 1115, which may be capable of transmitting or receiving wireless transmissions (e.g., concurrently). The transceiver 1110 may also include a modem to modulate signals, to provide the modulated signals for transmission (e.g., by one or more antennas 1115, by a wired transmitter), to receive modulated signals (e.g., from one or more antennas 1115, from a wired receiver), and to demodulate signals. In some implementations, the transceiver 1110 may include one or more interfaces, such as one or more interfaces coupled with the one or more antennas 1115 that are configured to support various receiving or obtaining operations, or one or more interfaces coupled with the one or more antennas 1115 that are configured to support various transmitting or outputting operations, or a combination thereof. In some implementations, the transceiver 1110 may include or be configured for coupling with one or more processors or one or more memory components that are operable to perform or support operations based on received or obtained information or signals, or to generate information or other signals for transmission or other outputting, or any combination thereof. In some implementations, the transceiver 1110, or the transceiver 1110 and the one or more antennas 1115, or the transceiver 1110 and the one or more antennas 1115 and one or more processors or one or more memory components (e.g., the at least one processor 1135, the at least one memory 1125, or both), may be included in a chip or chip assembly that is installed in the device 1105. In some examples, the transceiver 1110 may be operable to support communications via one or more communications links (e.g., communication link(s) 125, backhaul communication link(s) 120, a midhaul communication link 162, a fronthaul communication link 168).

The at least one memory 1125 may include RAM, ROM, or any combination thereof. The at least one memory 1125 may store computer-readable, computer-executable, or processor-executable code, such as the code 1130. The code 1130 may include instructions that, when executed by one or more of the at least one processor 1135, cause the device 1105 to perform various functions described herein. The code 1130 may be stored in a non-transitory computer-readable medium such as system memory or another type of memory. In some cases, the code 1130 may not be directly executable by a processor of the at least one processor 1135 but may cause a computer (e.g., when compiled and executed) to perform functions described herein. In some cases, the at least one memory 1125 may include, among other things, a BIOS which may control basic hardware or software operation such as the interaction with peripheral components or devices. In some examples, the at least one processor 1135 may include multiple processors and the at least one memory 1125 may include multiple memories. One or more of the multiple processors may be coupled with one or more of the multiple memories which may, individually or collectively, be configured to perform various functions herein (for example, as part of a processing system).

The at least one processor 1135 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1135 may be configured to operate a memory array using a memory controller. In some other cases, a memory controller may be integrated into one or more of the at least one processor 1135. The at least one processor 1135 may be configured to execute computer-readable instructions stored in a memory (e.g., one or more of the at least one memory 1125) to cause the device 1105 to perform various functions (e.g., functions or tasks supporting resolving ambiguity of UE serving location in mobility procedures). For example, the device 1105 or a component of the device 1105 may include at least one processor 1135 and at least one memory 1125 coupled with one or more of the at least one processor 1135, the at least one processor 1135 and the at least one memory 1125 configured to perform various functions described herein. The at least one processor 1135 may be an example of a cloud-computing platform (e.g., one or more physical nodes and supporting software such as operating systems, virtual machines, or container instances) that may host the functions (e.g., by executing code 1130) to perform the functions of the device 1105. The at least one processor 1135 may be any one or more suitable processors capable of executing scripts or instructions of one or more software programs stored in the device 1105 (such as within one or more of the at least one memory 1125).

In some examples, the at least one processor 1135 may include multiple processors and the at least one memory 1125 may include multiple memories. One or more of the multiple processors may be coupled with one or more of the multiple memories, which may, individually or collectively, be configured to perform various functions herein. In some examples, the at least one processor 1135 may be a component of a processing system, which may refer to a system (such as a series) of machines, circuitry (including, for example, one or both of processor circuitry (which may include the at least one processor 1135) and memory circuitry (which may include the at least one memory 1125)), or components, that receives or obtains inputs and processes the inputs to produce, generate, or obtain a set of outputs. The processing system may be configured to perform one or more of the functions described herein. For example, the at least one processor 1135 or a processing system including the at least one processor 1135 may be configured to, configurable to, or operable to cause the device 1105 to perform one or more of the functions described herein. Further, as described herein, being “configured to,” being “configurable to,” and being “operable to” may be used interchangeably and may be associated with a capability, when executing code stored in the at least one memory 1125 or otherwise, to perform one or more of the functions described herein.

In some examples, a bus 1140 may support communications of (e.g., within) a protocol layer of a protocol stack. In some examples, a bus 1140 may support communications associated with a logical channel of a protocol stack (e.g., between protocol layers of a protocol stack), which may include communications performed within a component of the device 1105, or between different components of the device 1105 that may be co-located or located in different locations (e.g., where the device 1105 may refer to a system in which one or more of the communications manager 1120, the transceiver 1110, the at least one memory 1125, the code 1130, and the at least one processor 1135 may be located in one of the different components or divided between different components).

In some examples, the communications manager 1120 may manage aspects of communications with a core network 130 (e.g., via one or more wired or wireless backhaul links). For example, the communications manager 1120 may manage the transfer of data communications for client devices, such as one or more UEs 115. In some examples, the communications manager 1120 may manage communications with one or more other network entities 105, and may include a controller or scheduler for controlling communications with UEs 115 (e.g., in cooperation with the one or more other network devices). In some examples, the communications manager 1120 may support an X2 interface within an LTE/LTE-A wireless communications network technology to provide communication between network entities 105.

The communications manager 1120 may support wireless communications in accordance with examples as disclosed herein. For example, the communications manager 1120 is capable of, configured to, or operable to support a means for obtaining an indication from a UE that an LTM procedure has occurred, where the LTM procedure includes the UE transferring a communication session from a second source network entity to the first source network entity. The communications manager 1120 is capable of, configured to, or operable to support a means for outputting, based on the UE transferring the communication session, one or more access notifications to one or more candidate network entities. The communications manager 1120 is capable of, configured to, or operable to support a means for obtaining, from at least one of the one or more candidate network entities, one or more updated configuration indications based on the one or more access notifications, where the one or more updated configuration indications indicate updated LTM procedure information at one or more of the one or more candidate network entities.

Additionally, or alternatively, the communications manager 1120 may support wireless communications in accordance with examples as disclosed herein. For example, the communications manager 1120 is capable of, configured to, or operable to support a means for obtaining a first indication of a configuration indicating the first network entity is one of one or more candidate network entities configured for an LTM procedure for a UE. The communications manager 1120 is capable of, configured to, or operable to support a means for updating LTM procedure information associated with the LTM procedure. The communications manager 1120 is capable of, configured to, or operable to support a means for outputting one or more updated configuration indications to at least one of the one or more candidate network entities based on updating the LTM procedure information.

Additionally, or alternatively, the communications manager 1120 may support wireless communications in accordance with examples as disclosed herein. For example, the communications manager 1120 is capable of, configured to, or operable to support a means for obtaining a first indication of a configuration indicating the anchor network entity is a communication anchor for one or more candidate network entities configured for an LTM procedure for a UE. The communications manager 1120 is capable of, configured to, or operable to support a means for obtaining one or more updated configuration indications from at least one candidate network entity of the one or more candidate network entities based on the first indication of the configuration indicating the anchor network entity being configured as the communication anchor. The communications manager 1120 is capable of, configured to, or operable to support a means for forwarding, based at least in part on obtaining the one or more updated configuration indications from the at least one candidate network entity, the one or more updated configuration indications to the one or more candidate network entities.

By including or configuring the communications manager 1120 in accordance with examples as described herein, the device 1105 may support techniques for resolving ambiguity of UE location, which may result in various advantages, such as improved communication reliability, reduced latency, improved user experience related to reduced processing, reduced power consumption, more efficient utilization of communication resources, improved coordination between devices, longer battery life, improved utilization of processing capability, etc.

In some examples, the communications manager 1120 may be configured to perform various operations (e.g., receiving, obtaining, monitoring, outputting, transmitting) using or otherwise in cooperation with the transceiver 1110, the one or more antennas 1115 (e.g., where applicable), or any combination thereof. Although the communications manager 1120 is illustrated as a separate component, in some examples, one or more functions described with reference to the communications manager 1120 may be supported by or performed by the transceiver 1110, one or more of the at least one processor 1135, one or more of the at least one memory 1125, the code 1130, or any combination thereof (for example, by a processing system including at least a portion of the at least one processor 1135, the at least one memory 1125, the code 1130, or any combination thereof). For example, the code 1130 may include instructions executable by one or more of the at least one processor 1135 to cause the device 1105 to perform various aspects of resolving ambiguity of UE serving location in mobility procedures as described herein, or the at least one processor 1135 and the at least one memory 1125 may be otherwise configured to, individually or collectively, perform or support such operations.

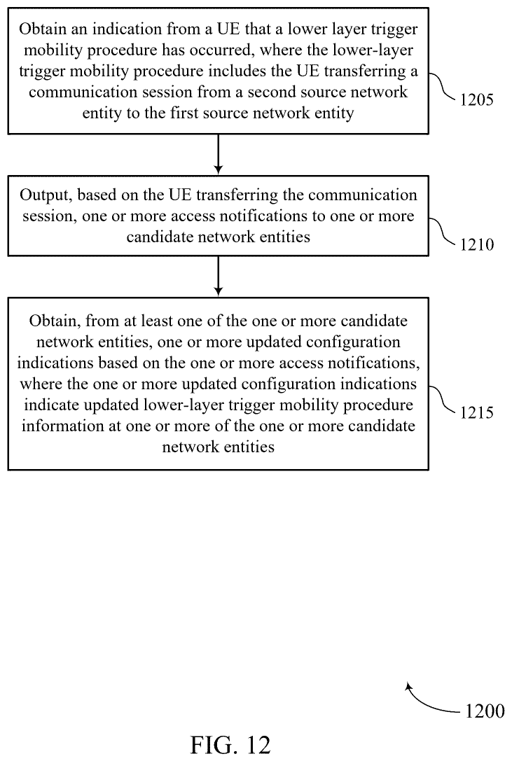

FIG. 12 shows a flowchart illustrating a method 1200 that supports resolving ambiguity of UE serving location in mobility procedures in accordance with one or more aspects of the present disclosure. The operations of the method 1200 may be implemented by a network entity or its components as described herein. For example, the operations of the method 1200 may be performed by a network entity as described with reference to FIGS. 1 through 11. In some examples, a network entity may execute a set of instructions to control the functional elements of the network entity to perform the described functions. Additionally, or alternatively, the network entity may perform aspects of the described functions using special-purpose hardware.

At 1205, the method may include obtaining an indication from a UE that an LTM procedure has occurred, where the LTM procedure includes the UE transferring a communication session from a second source network entity to the first source network entity. The operations of 1205 may be performed in accordance with examples as disclosed herein. In some examples, aspects of the operations of 1205 may be performed by a UE indication obtaining component 1025 as described with reference to FIG. 10.

At 1210, the method may include outputting, based on the UE transferring the communication session, one or more access notifications to one or more candidate network entities. The operations of 1210 may be performed in accordance with examples as disclosed herein. In some examples, aspects of the operations of 1210 may be performed by an access notification output component 1030 as described with reference to FIG. 10.

At 1215, the method may include obtaining, from at least one of the one or more candidate network entities, one or more updated configuration indications based on the one or more access notifications, where the one or more updated configuration indications indicate updated LTM procedure information at one or more of the one or more candidate network entities. The operations of 1215 may be performed in accordance with examples as disclosed herein. In some examples, aspects of the operations of 1215 may be performed by an updated configuration indication obtaining component 1035 as described with reference to FIG. 10.

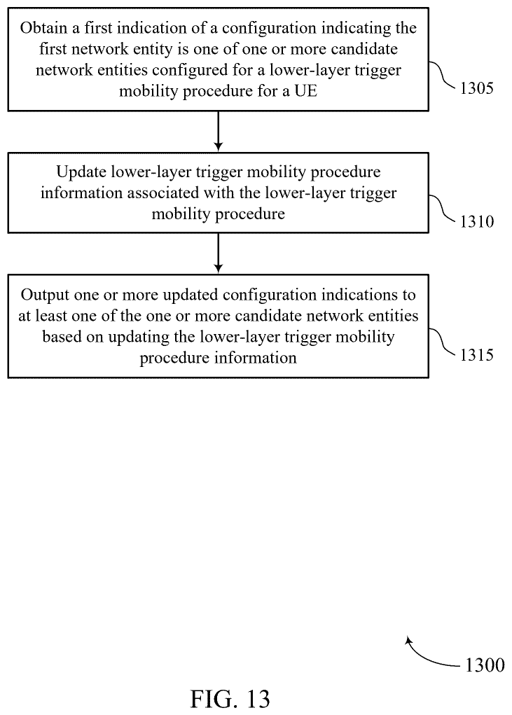

FIG. 13 shows a flowchart illustrating a method 1300 that supports resolving ambiguity of UE serving location in mobility procedures in accordance with one or more aspects of the present disclosure. The operations of the method 1300 may be implemented by a network entity or its components as described herein. For example, the operations of the method 1300 may be performed by a network entity as described with reference to FIGS. 1 through 11. In some examples, a network entity may execute a set of instructions to control the functional elements of the network entity to perform the described functions. Additionally, or alternatively, the network entity may perform aspects of the described functions using special-purpose hardware.

At 1305, the method may include obtaining a first indication of a configuration indicating the first network entity is one of one or more candidate network entities configured for an LTM procedure for a UE. The operations of 1305 may be performed in accordance with examples as disclosed herein. In some examples, aspects of the operations of 1305 may be performed by a configuration obtaining component 1040 as described with reference to FIG. 10.

At 1310, the method may include updating LTM procedure information associated with the LTM procedure. The operations of 1310 may be performed in accordance with examples as disclosed herein. In some examples, aspects of the operations of 1310 may be performed by a procedure information updating component 1045 as described with reference to FIG. 10.

At 1315, the method may include outputting one or more updated configuration indications to at least one of the one or more candidate network entities based on updating the LTM procedure information. The operations of 1315 may be performed in accordance with examples as disclosed herein. In some examples, aspects of the operations of 1315 may be performed by an updated configuration indication output component 1050 as described with reference to FIG. 10.

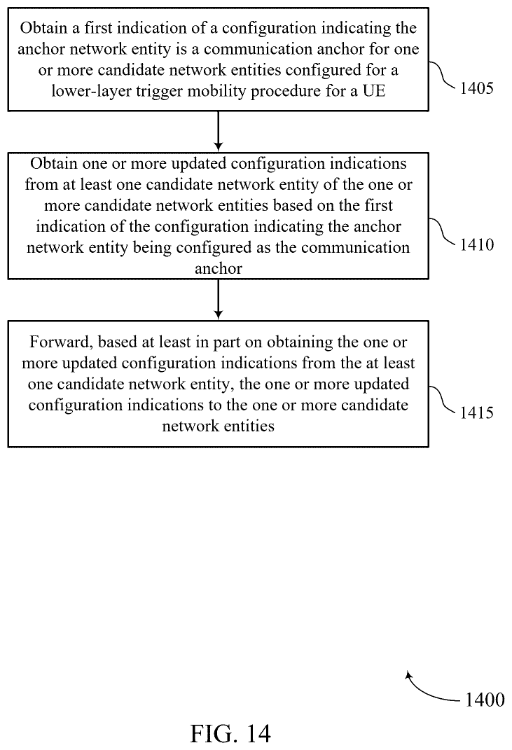

FIG. 14 shows a flowchart illustrating a method 1400 that supports resolving ambiguity of UE serving location in mobility procedures in accordance with one or more aspects of the present disclosure. The operations of the method 1400 may be implemented by a network entity or its components as described herein. For example, the operations of the method 1400 may be performed by a network entity as described with reference to FIGS. 1 through 11. In some examples, a network entity may execute a set of instructions to control the functional elements of the network entity to perform the described functions. Additionally, or alternatively, the network entity may perform aspects of the described functions using special-purpose hardware.

At 1405, the method may include obtaining a first indication of a configuration indicating the anchor network entity is a communication anchor for one or more candidate network entities configured for an LTM procedure for a UE. The operations of 1405 may be performed in accordance with examples as disclosed herein. In some examples, aspects of the operations of 1405 may be performed by a configuration obtaining component 1040 as described with reference to FIG. 10.

At 1410, the method may include obtaining one or more updated configuration indications from at least one candidate network entity of the one or more candidate network entities based on the first indication of the configuration indicating the anchor network entity being configured as the communication anchor. The operations of 1410 may be performed in accordance with examples as disclosed herein. In some examples, aspects of the operations of 1410 may be performed by an updated configuration indication obtaining component 1035 as described with reference to FIG. 10.

At 1415, the method may include forwarding, based on obtaining the one or more updated configuration indications from the at least one candidate network entity, the one or more updated configuration indications to the one or more candidate network entities. The operations of 1415 may be performed in accordance with examples as disclosed herein. In some examples, aspects of the operations of 1415 may be performed by an updated configuration indication forwarding component 1055 as described with reference to FIG. 10.

The following provides an overview of aspects of the present disclosure:

Aspect 1: A method for wireless communications at a first source network entity, comprising: obtaining an indication from a UE that a LTM procedure has occurred, wherein the LTM procedure comprises the UE transferring a communication session from a second source network entity to the first source network entity; outputting, based at least in part on the UE transferring the communication session, one or more access notifications to one or more candidate network entities; and obtaining, from at least one of the one or more candidate network entities, one or more updated configuration indications based at least in part on the one or more access notifications, wherein the one or more updated configuration indications indicate updated LTM procedure information at one or more of the one or more candidate network entities.

Aspect 2: The method of aspect 1, wherein outputting the one or more access notifications comprises: outputting a first access notification to the second source network entity; and outputting one or more second access notifications to one or more other network entities, wherein the first access notification indicates successful transfer of the communication session to the first source network entity and wherein the one or more second access notifications indicate that the first source network entity is a serving entity of the UE.

Aspect 3: The method of any of aspects 1 through 2, wherein outputting the one or more access notifications comprises: outputting a first access notification to the second source network entity, wherein obtaining the one or more updated configuration indications is further based at least in part on signaling transmitted, in response to the first access notification, from the second source network entity to one or more of the one or more candidate network entities.

Aspect 4: The method of any of aspects 1 through 3, further comprising: output one or more reconfiguration messages to the UE based at least in part on the one or more updated configuration indications.

Aspect 5: The method of aspect 4, wherein the one or more reconfiguration messages comprise radio resource control signaling.

Aspect 6: The method of any of aspects 1 through 5, wherein obtaining the indication from the UE is further based at least in part on a prior mobility procedure other than a successful LTM procedure.

Aspect 7: A first source network entity for wireless communications, comprising one or more memories storing processor-executable code, and one or more processors coupled with the one or more memories and individually or collectively operable to execute the code to cause the first source network entity to perform a method of any of aspects 1 through 7.

Aspect 8: A first source network entity for wireless communications, comprising at least one means for performing a method of any of aspects 1 through 6.

Aspect 9: A non-transitory computer-readable medium storing code for wireless communications, the code comprising instructions executable by one or more processors to perform a method of any of aspects 1 through 6.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first source network entity, comprising:
one or more memories storing processor-executable code; and
one or more processors coupled with the one or more memories and individually or collectively operable to execute the code to cause the first source network entity to:
obtain an indication from a user equipment (UE) that a lower-layer trigger mobility procedure has occurred, wherein the lower-layer trigger mobility procedure comprises the UE transferring a communication session from a second source network entity to the first source network entity;
output, based at least in part on the UE transferring the communication session, one or more access notifications to one or more candidate network entities; and
obtain, from at least one of the one or more candidate network entities, one or more updated configuration indications based at least in part on the one or more access notifications, wherein the one or more updated configuration indications indicate updated lower-layer trigger mobility procedure information at one or more of the one or more candidate network entities.

2. The first source network entity of claim 1, wherein, to output the one or more access notifications, the one or more processors are individually or collectively operable to execute the code to cause the first source network entity to:
output a first access notification to the second source network entity; and
output one or more second access notifications to one or more other network entities, wherein the first access notification indicates successful transfer of the communication session to the first source network entity and wherein the one or more second access notifications indicate that the first source network entity is a serving entity of the UE.

3. The first source network entity of claim 1, wherein, to output the one or more access notifications, the one or more processors are individually or collectively operable to execute the code to cause the first source network entity to:
output a first access notification to the second source network entity, wherein obtaining the one or more updated configuration indications is further based at least in part on signaling transmitted, in response to the first access notification, from the second source network entity to one or more of the one or more candidate network entities.

4. The first source network entity of claim 1, wherein the one or more processors are individually or collectively further operable to execute the code to cause the first source network entity to:
output one or more reconfiguration messages to the UE based at least in part on the one or more updated configuration indications.

5. The first source network entity of claim 4, wherein the one or more reconfiguration messages comprise radio resource control signaling.

6. The first source network entity of claim 1, wherein obtaining the indication from the UE is further based at least in part on a prior mobility procedure other than a successful lower-layer trigger mobility procedure.

7. A method for wireless communications at a first source network entity, comprising:
obtaining an indication from a user equipment (UE) that a lower-layer trigger mobility procedure has occurred, wherein the lower-layer trigger mobility procedure comprises the UE transferring a communication session from a second source network entity to the first source network entity;
outputting, based at least in part on the UE transferring the communication session, one or more access notifications to one or more candidate network entities; and
obtaining, from at least one of the one or more candidate network entities, one or more updated configuration indications based at least in part on the one or more access notifications, wherein the one or more updated configuration indications indicate updated lower-layer trigger mobility procedure information at one or more of the one or more candidate network entities.

8. The method of claim 7, wherein outputting the one or more access notifications comprises:
outputting a first access notification to the second source network entity; and
outputting one or more second access notifications to one or more other network entities, wherein the first access notification indicates successful transfer of the communication session to the first source network entity and wherein the one or more second access notifications indicate that the first source network entity is a serving entity of the UE.

9. The method of claim 7, wherein outputting the one or more access notifications comprises:
outputting a first access notification to the second source network entity, wherein obtaining the one or more updated configuration indications is further based at least in part on signaling transmitted, in response to the first access notification, from the second source network entity to one or more of the one or more candidate network entities.

10. The method of claim 7, further comprising:
outputting one or more reconfiguration messages to the UE based at least in part on the one or more updated configuration indications.

11. The method of claim 10, wherein the one or more reconfiguration messages comprise radio resource control signaling.

12. The method of claim 7, wherein obtaining the indication from the UE is further based at least in part on a prior mobility procedure other than a successful lower-layer trigger mobility procedure.

13. A non-transitory computer-readable medium storing code for wireless communications, the code comprising instructions executable by one or more processors to:
obtain an indication from a user equipment (UE) that a lower-layer trigger mobility procedure has occurred, wherein the lower-layer trigger mobility procedure comprises the UE transferring a communication session from a second source network entity to a first source network entity;
output, based at least in part on the UE transferring the communication session, one or more access notifications to one or more candidate network entities; and
obtain, from at least one of the one or more candidate network entities, one or more updated configuration indications based at least in part on the one or more access notifications, wherein the one or more updated configuration indications indicate updated lower-layer trigger mobility procedure information at one or more of the one or more candidate network entities.

14. The non-transitory computer-readable medium of claim 13, wherein the instructions to output the one or more access notifications are executable by the one or more processors to:
output a first access notification to the second source network entity; and
output one or more second access notifications to one or more other network entities, wherein the first access notification indicates successful transfer of the communication session to the first source network entity and wherein the one or more second access notifications indicate that the first source network entity is a serving entity of the UE.

15. The non-transitory computer-readable medium of claim 13, wherein the instructions to output the one or more access notifications are executable by the one or more processors to:
output a first access notification to the second source network entity, wherein obtaining the one or more updated configuration indications is further based at least in part on signaling transmitted, in response to the first access notification, from the second source network entity to one or more of the one or more candidate network entities.

16. The non-transitory computer-readable medium of claim 13, wherein the instructions are further executable by the one or more processors to:
output one or more reconfiguration messages to the UE based at least in part on the one or more updated configuration indications.

17. The non-transitory computer-readable medium of claim 16, wherein the one or more reconfiguration messages comprise radio resource control signaling.

18. The non-transitory computer-readable medium of claim 13, wherein obtaining the indication from the UE is further based at least in part on a prior mobility procedure other than a successful lower-layer trigger mobility procedure.
